(19) United States
(12) Patent Application Publication
(10) Pub. No.: US 2015/0231638 A1
(43) Pub. Date: Aug. 20, 2015

(54) ORGANIC WASTE TREATMENT SYSTEM

(71) Applicant: PIONEER WASTE MANAGEMENT HOLDINGS TRUST PTY LIMITED, Taren Point, New South Wales (AU)

(72) Inventor: Noel Mancuso, Taren Point (AU)

(73) Assignee: PIONEER WASTE MANAGEMENT HOLDINGS TRUST PTY LIMITED, Taren Point, New South Wales (AU)

(21) Appl. No.: 14/424,972

(22) PCT Filed: Aug. 30, 2013
(86) PCT No.: PCT/AU2013/000983

§ 371 Date: Feb. 27, 2015

(30) Foreign Application Priority Data
Aug. 30, 2012 (AU) 2012903769

(51) Int. Cl. B02C 18/00; B02C 18/22; F04D 7/00; B02C 18/18

(52) U.S. Cl. CPC B02C 18/0084; B02C 18/18; B02C 18/2291; F04D 7/00

(57) ABSTRACT

A comminution unit for an organic waste treatment system is described. The comminution unit includes a comminution means for comminuting organic waste; a funnel assembly for receiving the organic waste, the funnel assembly being positioned above the comminution means and including at least one inwardly angled section for directing organic waste to the comminution means; a pre-processing assembly being positioned in the funnel assembly and above the comminution means, the pre-processing assembly adapted to agitate and shred the organic waste; a motor for driving the comminution means and the pre-processing assembly about an axis of rotation; and a waste outlet positioned below the comminution means and via which comminuted organic waste is transported away from the comminution unit. The pre-processing assembly includes one or more arms extending radially from the axis of rotation.

### FIELD OF THE INVENTION

The present invention relates to an organic waste treatment system.

### BACKGROUND OF THE INVENTION

Some types of organic waste treatment systems are operable to comminute organic waste into a slurry or pulp for transport away from the point at which comminution occurs. Such systems can be installed and used in any environment where organic waste is produced, for example, domestic and commercial kitchens, food courts, fruit and vegetable shops, hospitals, fast food outlets, clubs, bakeries, supermarkets, and suchlike.

Examples of such units are described in PCT patent applications PCT/AU2004/001460 (international filing date 22 Oct. 2004) and PCT/AU2008/000685 (international filing date 15 May 2008).

At a general level, such waste treatment systems operate by comminuting organic waste and adding water to form a slurry which is transported to a catchment area/holding tank or, in some instances, directly to a sewer or other outlet.

By processing organic waste in this way, disposing of organic waste in landfill can be avoided. Further, by carefully controlling the waste treatment process it is possible to generate a useful product for use, for example, as a fuel source for bio-digestion processes. A problem for biogas producers such as BTA is that the biological waste feed collected for the biogas digester can be contaminated with inorganic materials.

It would be desirable to provide an organic waste treatment system for efficiently processing organic waste. Alternatively, or in addition, it would be desirable to provide an organic waste treatment system for generating an organic waste stream for use in the production of biogas. Further alternatively, or additionally, it would be desirable to provide a useful alternative to existing organic waste treatment systems.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In one aspect the present invention provides a comminution unit for an organic waste treatment system, the comminution unit including: a comminution means for comminuting organic waste; a funnel assembly for receiving the organic waste, the funnel assembly being positioned above the comminution means and including at least one inwardly angled section for directing organic waste to the comminution means; a pre-processing assembly being positioned in the funnel assembly and above the comminution means, the pre-processing assembly adapted to agitate and shred the organic waste; a motor for driving the comminution means and the pre-processing assembly about an axis of rotation; and a waste outlet positioned below the comminution means and via which comminuted organic waste is transported away from the comminution unit, wherein the pre-processing assembly includes one or more arms extending radially from the axis of rotation.

In a second aspect the present invention provides a pump assembly for an organic waste treatment system, the pump assembly including: a pump motor for driving the pump assembly; an inlet for receiving water and comminuted organic waste; an outlet through which the comminuted organic waste is pumped by a pump mechanism; a suction chamber between the pump assembly inlet and the pump assembly outlet; and a pump assembly water inlet for admitting water into the suction chamber.

In a third aspect the present invention provides an organic waste treatment system including: a funnel assembly for receiving organic waste; a comminution means for comminuting the organic waste, the comminution means being located downstream of the funnel assembly; a motor for driving the comminution means; a pump assembly for pumping comminuted organic waste away from the comminution means, the pump assembly including: a pump assembly inlet for receiving the comminuted organic waste; a pump assembly outlet through which the comminuted organic waste is pumped by a pump mechanism; and a suction chamber located between the pump assembly inlet and the pump assembly outlet, wherein the organic waste treatment system further includes a main water inlet connected by plumbing to: one or more water sprays located in the funnel assembly; a first pump assembly water inlet for admitting water at a location between the comminution means and the pump assembly inlet; and a second pump assembly water inlet for inletting water into the suction chamber.

Also described herein is a comminution unit for an organic waste treatment system, the comminution unit including: a comminution means for comminuting organic waste, the comminution means being driven by a motor and including a pre-processing comminution means and a primary comminution means; a funnel assembly for receiving the organic waste and directing said organic waste to the comminution means; and a waste outlet via which comminuted organic waste is transported away from the comminution unit.

The pre-processing comminution means may be positioned in the funnel assembly and the primary comminution means may be positioned below the funnel assembly.

The pre-processing comminution means and the primary comminution means may have a common axis of rotation.

The pre-processing comminution means may include one or more arms extending radially from the axis of rotation.

The one or more arms may include one or more vanes, each vane extending from one of the one or more arms. Each vane may extend approximately normally from one of the one or more arms. Each vane may extend from one of the one or more arms upwardly, or in a direction away from the primary comminution means. Each vane may be arcuate.

The pre-processing comminution means may include at least two vanes, each vane tracing a distinct circular path on rotation of the pre-processing means by the motor.

The pre-processing comminution means may include four arms. The four arms may be equiangularly spaced around the axis of rotation. Each arm may carry at least one vane. Each arm may two vanes positioned at different radial distances from the axis of rotation.

The pre-processing comminution means may include a spindle which carries the one or more arms and engages with a drive shaft which is operatively coupled to the motor.

The primary comminution means may be a circular rotor plate.

The primary comminution means may engage with the drive shaft.

A magnetic field may be provided at at least a portion of a wall of the funnel assembly to capture magnetic objects introduced into the funnel assembly against the wall.

Also described herein is a pump assembly for an organic waste treatment system, the pump assembly including: an inlet for receiving comminuted organic waste; an outlet through which the comminuted organic waste is pumped by a pump mechanism; and a sump for capturing metallic objects passing through the pump assembly.

The sump may be provided with one or more rare earth magnets for attracting the metallic objects.

The pump assembly may include a suction chamber between the pump assembly inlet and the pump assembly outlet, and the sump may be provided at an operative base of the suction chamber.

The suction chamber may include a suction chamber water inlet for admitting water directly into the suction chamber.

The pump assembly may also include a main water inlet for admitting water at the pump assembly inlet.

The pump assembly may include a pump motor having a pump assembly drive shaft, and a pump rotor attached to the pump assembly drive shaft motor using at least one fastener.

The at least one fastener may permit the pump mechanism to be operated in both forward and reverse directions without decoupling of the pump rotor from the pump assembly drive shaft.

The pump rotor may be a worm drive rotor.

The at least one fastener may be one or more grub screws.

The pump assembly may include a macerator for macerating organic waste pumped through the pump assembly.

Also described herein is a comminution unit for an organic waste treatment system, the comminution unit including: a comminution means for comminuting organic waste, the comminution means being driven by a motor; a funnel assembly operatively positioned above the comminution means for receiving the organic waste and directing said organic waste to the comminution means; a waste outlet via which comminuted organic waste is transported away from the comminution unit, and a magnetic field at at least a portion of a wall of the funnel assembly to capture magnetic objects introduced into the funnel assembly against the wall.

The magnetic field may substantially cover the entire wall of the funnel assembly.

The magnetic field may be provided by one or more rare earth magnets positioned on or near an outside surface of the wall.

Also described herein is a comminution unit for an organic waste treatment system, the comminution unit including: a comminution means for comminuting organic waste, the comminution means being driven by a motor; a pump assembly downstream of the comminution means and in fluid communication therewith, the pump assembly having a forward operation direction for pumping material away from the comminution means and a reverse operation direction for pumping material towards the comminution means, and a control unit for controlling operation of the comminution means and the pump assembly during operational cycles of the comminution unit, wherein on receiving a signal to commence an operational cycle the control unit is configured to operate the pump assembly in the reverse direction for a predetermined period of time in order to clear residual comminuted waste from the pump assembly.

On receiving a signal to commence the operational cycle, and after operating the pump assembly in the reverse direction for the predetermine period of time, the control unit may be further configured to operate the comminution means to commence comminution of the organic waste and operate the pump in the forward direction to pump comminuted organic waste away from the comminution unit.

The pump assembly may include a pump motor having a pump assembly drive shaft, and a pump rotor attached to the pump assembly drive shaft motor using at least one fastener allowing the pump assembly to be operated in both forward and reverse directions without decoupling of the pump rotor from the pump assembly drive shaft.

The pump rotor may be a worm drive rotor.

The at least one fastener may be one or more grub screws.

The pump assembly may be in fluid communication with a holding tank, and operation of the pump assembly in the forward direction may pump material to the holding tank.

The pump assembly may include a suction chamber between the pump assembly inlet and the pump assembly outlet, and the sump may be provided at an operative base of the suction chamber.

The suction chamber may include a suction chamber water inlet for admitting water directly into the suction chamber.

The comminution unit may also include a main pump water inlet for admitting water at the pump assembly inlet.

The pump assembly may include a macerator for macerating organic waste pumped through the pump assembly.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 provides a schematic diagram of an organic waste treatment system in accordance with an embodiment of the invention.

FIG. 2 provides a depiction of a comminution unit suitable for use with the organic waste treatment system of FIG. 1.

FIG. 3A provides a partial cross-sectional elevation view of a processing unit suitable for use with the comminution unit of FIG. 2.

FIG. 3B provides an alternative partial cross-sectional elevation view of the processing unit of FIG. 3A, the section of FIG. 3B being at 90° to the section shown in FIG. 3A.

FIG. 3C provides a partial perspective view of the processing unit shown in FIGS. 3A and 3B.

FIG. 3D provides a schematic top view of the pre-processing means of the processing unit of FIGS. 3A to 3C.

FIG. 3E provides a partial perspective view of a processing unit in accordance with an alternative embodiment of the invention.

FIG. 4A provides a schematic sectional view of a pump assembly for use with the waste treatment system of FIG. 1 and in accordance with an embodiment of the invention.

FIG. 4B provides a perspective view of the pump suction chamber of the pump assembly of FIG. 4A.

FIG. 4C provides a front view of the pump suction chamber of FIG. 4B.

FIG. 4D provides a top view of the pump suction chamber of FIG. 4B.

FIG. 4E provides a left elevation view of the pump suction chamber of FIG. 4B.

FIG. 4F provides a sectional view of the pump suction chamber taken along section A-A of FIG. 4E.

FIG. 5 provides a logic diagram of a control unit for use with the waste processing system of FIG. 1, together with its connections to various logical components of the waste processing system.

FIG. 6A provides a flow chart depicting the operation of the waste processing system during an automatic processing cycle.

FIG. 6B provides a flow chart depicting the operation of the waste processing system during a liquid processing cycle.

FIG. 6C provides a flow chart depicting the operation of the waste processing system during a wash cycle.

FIG. 6D provides a flow chart depicting the operation of the waste processing system on activation of an emergency stop control.

FIG. 6E provides a flow chart depicting the operation of the waste processing system on activation of a lid control.

FIG. 7 provides a schematic of the plumbing of the comminution unit of FIG. 2.

FIG. 8 provides a depiction of a holding tank suitable for use with the organic waste treatment system of FIG. 1.

FIG. 9 provides a block diagram of a computing device suitable for implementing various aspects of the invention.

### DETAILED DESCRIPTION OF THE EMBODIMENTS

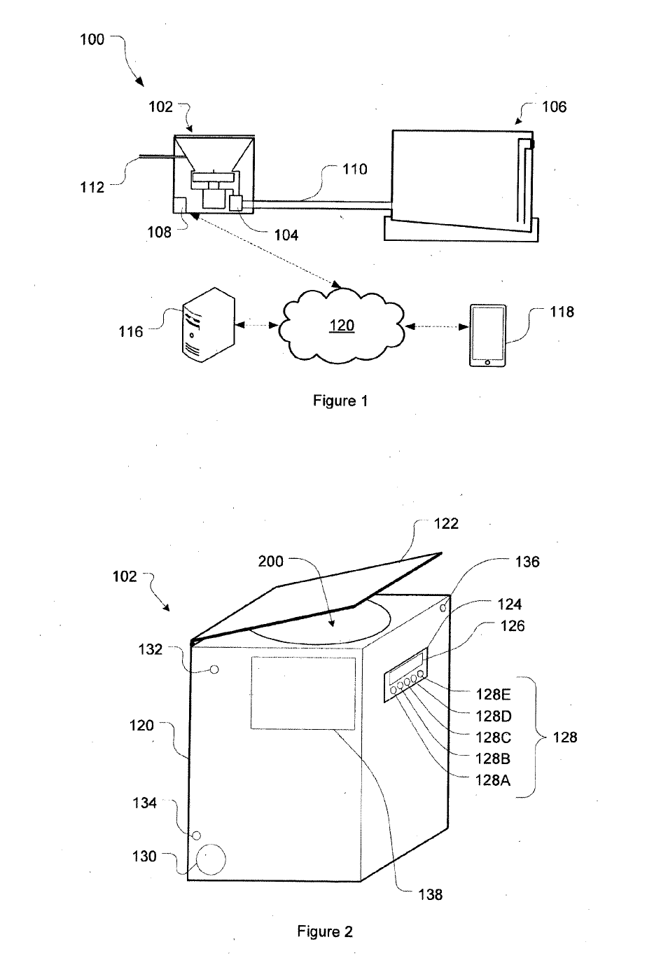

Referring to FIG. 1, a broad overview of an organic waste treatment system 100 in accordance with an embodiment of the invention will first be provided. Following this overview various sub-components and features of the system will be described in further detail.

Overview

Organic waste treatment system 100 includes a comminution unit 102, a pump assembly 104 (in this instance a component of the comminution unit 102), a holding tank 106, and a control unit 108 (again, in this instance, being illustrated as part of the comminution unit 200). The comminution unit 102 is connected to the holding tank 106 by a waste transportation line 110. The comminution unit 102 is also connected to a water supply by a water supply line 112 and to a power source by a power supply line (not shown).

Operation of the comminution unit 102 (and the various sub-components thereof) is controlled by control unit 108. System 100 also includes a communication device (in this instance part of the control unit 108) which is configured to communicate information to, and receive information from, remote sources such as server 116 and/or remote device 118. This communication is via a network 120 (such as the Internet).

In use, organic waste is fed into the comminution unit 102 where it is processed, if necessary with the addition of water supplied via the water supply line 112. The slurry resulting from the processing is pumped by pump assembly 104 through the waste transportation line 110 to the holding tank 106 where it is stored. Holding tank 106 is periodically emptied. Various operational data, such as the remaining capacity of the holding tank, may be automatically sent over the network 120 to the server 116 and/or device 118 (either directly or via server 116).

The slurry produced by the comminution unit and stored in the holding tank is, in itself, a useful and valuable waste stream. The slurry can be used, for example, as a rich feed source for biodigestors—anaerobic reactors where the slurry is used to produce ‘biogas’ which can be used as a fuel source to generate electricity. This technology has been implemented, for example, by Biotechnische Abfallverwertung GmbH Co KG (BTA). Alternatively, the slurry can be used for composting or soil injection.

Various components and features of the waste treatment system 100 will now be described in detail. It will be appreciated that while one aspect of the present invention relates to the waste treatment system 100 as a whole, other aspects of the invention relate to individual components and features thereof.

Comminution Unit

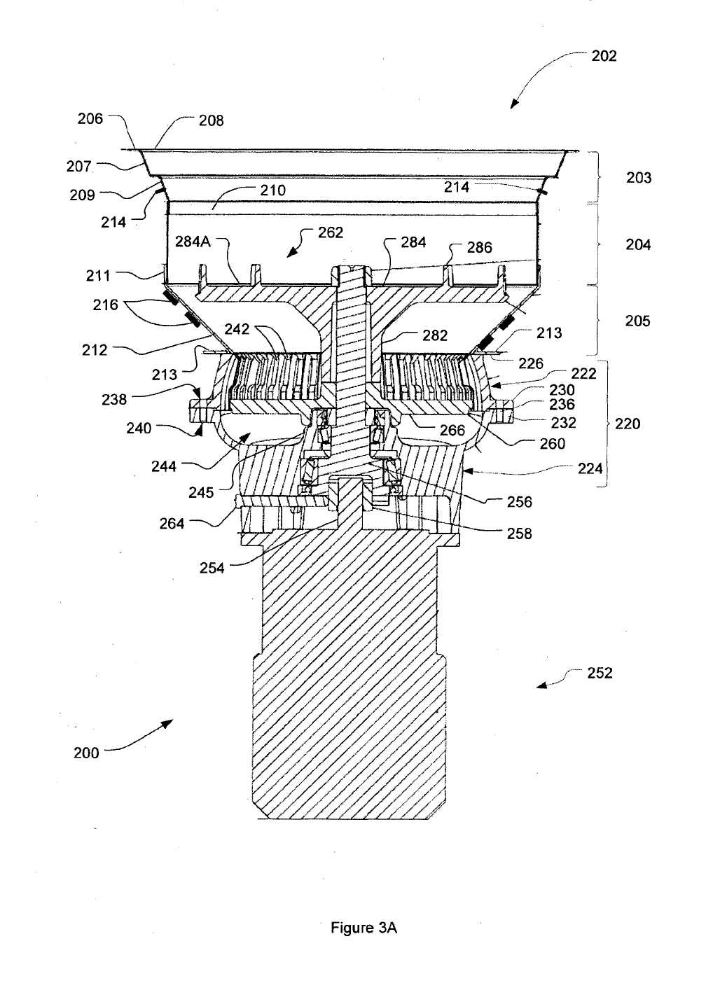

FIG. 2 is a perspective view of comminution unit 102. Unit 102 includes an external housing 120 with a hinged lid 122 moveable between an open position (shown) and a closed position by an electronic lid actuator (not shown).

The housing 120 is also provided with a control panel 124 which includes a display 126 and controls 128. As discussed below, the display 126 and controls 128 are operatively connected to the control unit 108 to allow information to be displayed on the display 126, and user input (via controls 128) to be entered and communicated to the control' unit 108. The display 126 may, for example, be a LCD or LED display (or any other type of display), and controls 128 may be simple push-button controls. Alternatively, the control panel 124 may include a touch screen display capable of displaying information and receiving user input according to detected touches (either by finger or stylus) on the touch screen.

In the illustrated embodiment five push button controls are provided, each control button for sending a signal to the control unit 108 to effect a specific operational function. These buttons include: a lid control 128A for opening/closing the lid 122; an automatic control button 128B for initiating an auto processing cycle; a liquid cycle control button 128C for initiating a liquid processing cycle; a wash cycle control button 128D for initiating a wash cycle; and an emergency stop button 128E for stopping operation of the comminution unit 102. Additional or alternative controls may, of course, be provided. Further alternatively, instead of dedicated control buttons operation of the system 100 may be by a menu driven user interface.

The housing 120 further includes a number of connection openings, such as a waste transportation line opening 130 (accommodating the waste transportation line 110), a water supply line opening 132 (accommodating the water supply line 112), a power supply line opening 134 for accommodating a power supply line, and openings for any other connections that may be necessary (e.g. a wired network connection if such is required). While these are all illustrated as discrete openings in the housing 120, it would, of course, be possible to have multiple lines passing through a single opening. Similarly, while the openings have been depicted as being on a side of the housing 120, they could be placed elsewhere (e.g. on the back, bottom, front, or opposite side) as appropriate for the requirements of a given installation.

Housing 120 also includes a power control 136 for switching the processing unit 200 on and off, and an access panel 138 providing access to the control unit 108.

The housing 120 may be made of any suitable material which is sturdy and, ideally, easy to clean—for example stainless steel. Further, to assist in maintenance the housing 120 may include additional removable panels to allow access to the internal components. The size of the comminution unit 102 will, of course, vary depending on its processing capacity (which, in turn, will depend on the intended use of the unit).

Housing 120 houses various components including, in this particular embodiment, a processing unit 200, the pump assembly 104, and the control unit 108, each of which will be described in detail below.

Processing Unit

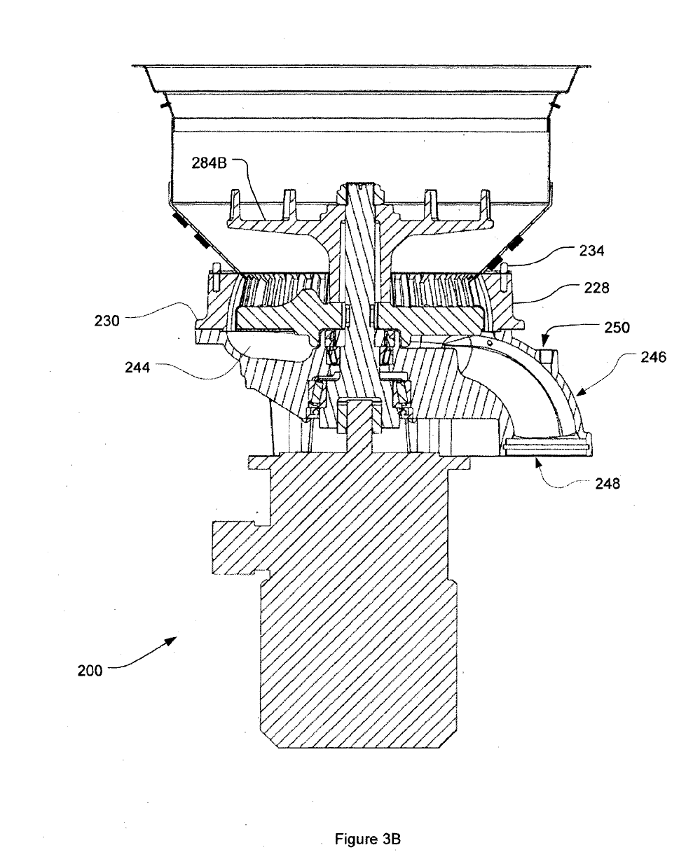

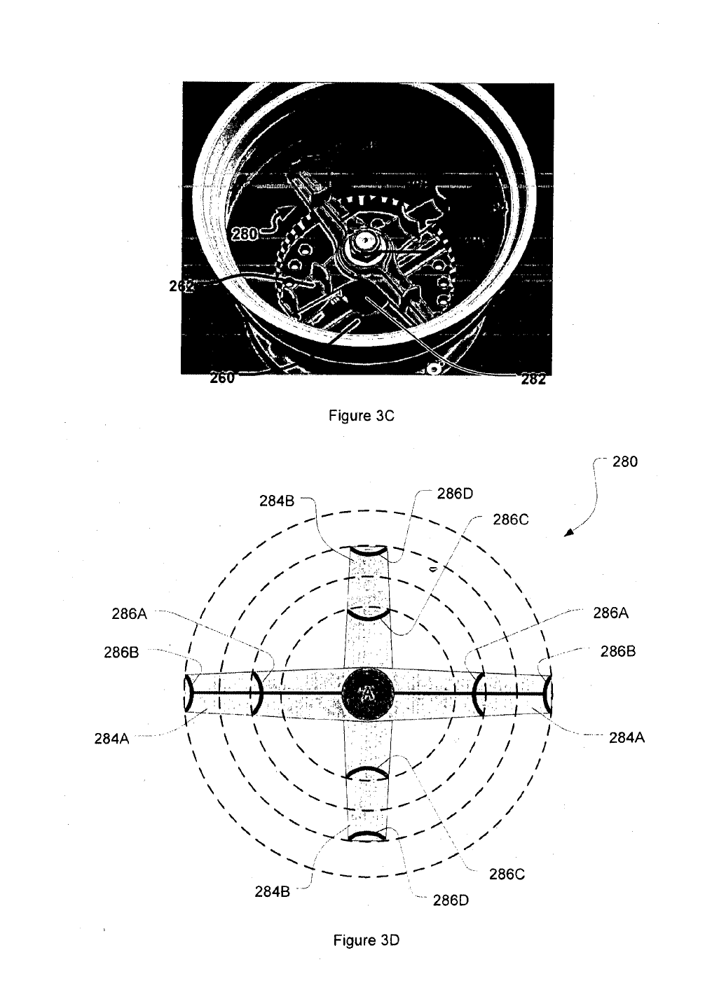

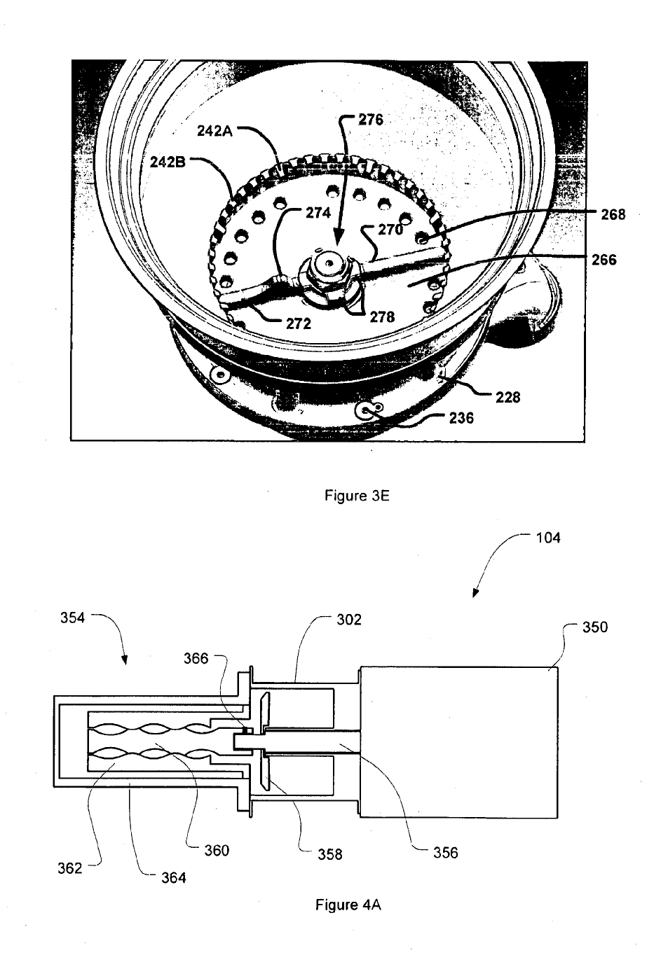

FIGS. 3A to 3E provide various views of a processing unit 200 suitable for use in the comminution unit 102 and in accordance with an embodiment of the invention.

Referring to FIG. 3A, processing unit 200 includes a funnel assembly 202 for receiving waste material to be processed, and which tapers generally inwardly from its mouth to its base. In this instance the funnel assembly 202 includes: an upper segment 203, a middle segment 204, and a lower segment 205.

The upper funnel segment 203 is a stepped funnel having (from top to bottom) an outwardly extending upper annular flange 206, an upper wall section 207 extending downwardly from the flange 206 and angled inwardly, a middle step section 208 extending inwardly from the bottom of the upper wall section 207 at an approximately horizontal angle, a middle wall section 209 extending downwardly from the inner edge of the step 208 and angled inwardly, and a lower wall section 210 extending approximately vertically downward from the middle wall 209.

The middle segment 204 of the funnel assembly is roughly cylindrical and at its top fits around/receives the lower wall section 210 of the upper funnel segment 203 at its top. The length of the middle segment 204 of the funnel assembly 202 can be selected so as to alter the capacity of the funnel assembly 202 (i.e. the amount of waste that can be held in the funnel assembly and processed by the unit in a single operational cycle). A longer middle segment 204 will provide a processing unit with a higher capacity than a shorter middle section.

The lower segment 205 includes a substantially vertical wall 211 (which fits around/receives the middle segment 204), a middle wall 212 (extending downwardly and inwardly from vertical wall section 211), and an outwardly (and approximately horizontally) extending lower flange 213 at its base.

The upper, middle and lower funnel assembly segments 203, 204, and 205 are, in the present embodiment, separate unitary components constructed from stainless steel and are welded together. Alternative materials may, of course, be used, and if desired the funnel assembly may be manufactured (e.g. spun) as a single component.

In use a splash guard (not shown) can be fitted in the top of the upper funnel section 203 (i.e. above the step 208).

The funnel assembly 202 is fitted with a plurality of water sprays 214. In this specific embodiment four sprays 214 are provided, evenly positioned around the circumference of the middle wall section 209 of the upper funnel segment 203, though additional or fewer sprays could be provided. Water sprays 214 are received in apertures (not shown) formed in the middle wall section and are approximately normal to the wall section 214. The water sprays used with the present embodiment have a spray angle of around 70 degrees and in use direct water into the funnel assembly and onto the underside of the lid 122 (cleaning the lid and preventing waste build-up thereon).

A series of magnets 216 (e.g. rare earth magnets) are located around the outer surface of the funnel assembly 202. Magnets 216 are positioned around the circumference of the lower funnel segment 205 (specifically middle wall 212) in a zigzag type pattern selected so as to provide a relatively even magnetic field around the lower segment 205/wall 212). The magnets 216 are held in position by double sided tape, though alternative fixing means are of course possible. The magnetic field provided by magnets 216 turns the lower funnel segment 205 into a primary capture point or zone for capturing metallic objects (such as cutlery) which may inadvertently be introduced into the processing unit 200.

The funnel assembly 202 sits atop a bowl assembly 220 having an upper body 222 sitting atop a lower body 224. The upper body 222 provides a stator for the grinding rotor discussed below. The top of the upper body 222 defines an upper rim 226. The upper body 222 also includes a plurality of shoulders 228 extending outwardly from the outer surface away from the sides of upper body 222 (two of which are visible in FIG. 3B and 3D). At its bottom the upper body 222 includes a lower apertured flange 230 which, when the processing unit 200 is assembled, abuts an upper apertured flange 232 of the lower bowl body 224.

The funnel assembly 202 is attached to the bowl assembly 220 by welding the lower flange 213 to the upper rim 226 of the upper bowl body 222, in addition to providing fasteners 234 (see FIG. 3B) which pass through corresponding pairs of apertures in the lower flange 213 and appropriately placed bores in the rim 226.

With respect to the bowl assembly 220, the upper body 222 is secured to the lower body 224 by a series of fasteners 236, each fastener 236 passing through/received in an aperture 238 in flange 230 of the upper body 222 and corresponding aperture 240 in flange 232 of the lower body 224. Alternative and/or additional means for securing the various components of the processing unit together are, of course, possible.

The inner surface of the upper bowl body 222 is formed with a plurality of ridges 242, each ridge extending down the length (or a portion thereof) of the upper body 222 and protruding inwardly towards the centre of the bowl assembly 220. The ridges 242 are sized and shaped so as to provide edges/surfaces against which waste is comminuted by a grinding rotor which rotates within the bowl assembly 220 (and which is discussed further below). Referring to FIG. 3E, to assist with the comminution process and agitation of the organic waste, the ridges 242 include a number of deep ridges 242A interspersed between shallow ridges 242B (the deep ridges 242A protruding further into the bowl body 222 than the shallow ribs 242B).

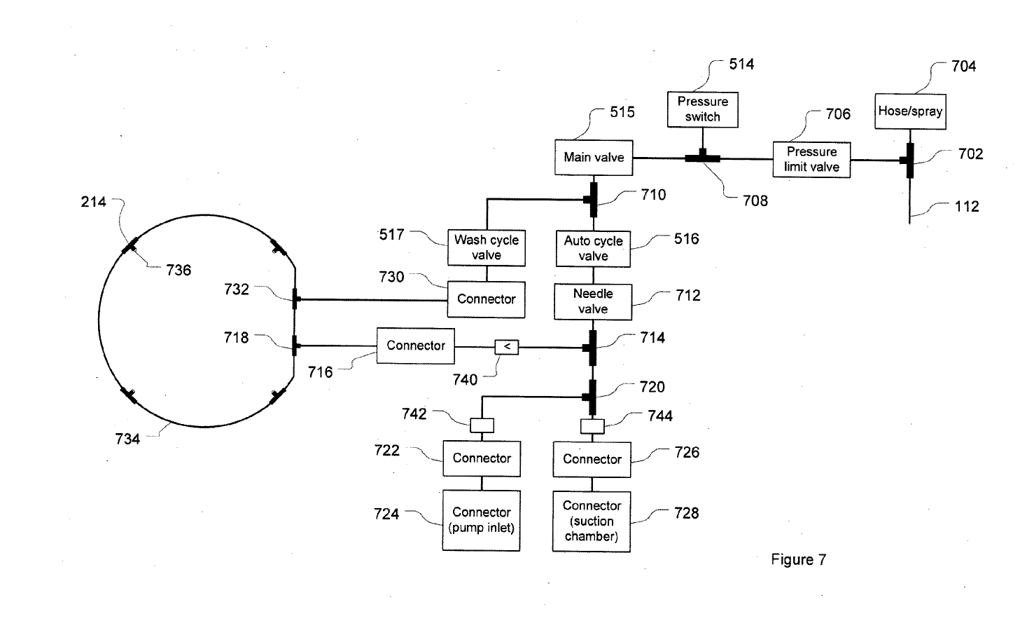

FIG. 3B shows a partial cross-sectional view of the processing unit at 90° to the section shown in FIG. 3A. The lower bowl body 224 defines an annular channel 244 surrounding a central raised hollow 245. At one side of the lower body 224 the channel 244 feeds into a downwardly directed outlet 246 which, in this case, is integrally cast with the rest of the lower body 224. The mouth of the outlet 246 is provided with a fitting 248 for forming a fluid tight connection with the pump assembly 104. A first pump assembly water inlet 250 is also located in the wall of the lower bowl body 224, approximately above the centre of the mouth of outlet 246. First pump assembly water inlet 250 receives a first pump assembly water supply line (see connector 724 of the plumbing schematic depicted in FIG. 7) which, in use, directs water into the pump assembly described below.

The bowl assembly 220 sits atop an electric comminution motor 252. Suitable motors include those manufactured by CMG Engineering Group, with the specific power being selected according to the intended operation of the processing unit. For example, a four kilowatt motor may be appropriate for processing units with a larger capacity and which include a pre-processing means (as discussed below) while a three kilowatt motor may be appropriate for processing units which have a smaller capacity and/or do not include a pre-processing means.

A motor shaft 254 extends upwardly from the comminution motor 252 and couples with a drive shaft 256 via a drive shaft coupling 258. Drive shaft 256 is, in turn, coupled to and drives the actual waste processing means which, in this embodiment, includes a primary comminution means 260 and a pre-processing means 262. Shaft 254 defines an axis of rotation of the waste processing means. A motor locking pin 264 is also provided.

The primary comminution means 260 of the present embodiment is a cast rotor/grinding plate 266. An unobscured top perspective view of rotor 266 is provided in FIG. 3E (which, as described further below, illustrates an embodiment of the invention which does not include the pre-processing means 262). Referring to FIG. 3A, the rotor 266 has a keyed central aperture through which the drive shaft 256 (which is complementally keyed to couple to the rotor) extends. The rotor 266 is positioned on the drive shaft 256 to be at the same height in the processing unit 200 as the ridges 242 of the bowl assembly 220. When the comminution motor 252 is operated the rotor 266 rotates about the axis of rotation within the bowl assembly 220 to comminute waste between the edge of the rotor 266 and the ridges 242.

Referring to FIG. 3E, the rotor 266 includes a plurality of apertures 268 through which comminuted waste and water can pass. The upper surface of the rotor 266 is provided with a pair of ridges 270 and 272 positioned diametrically opposite each other and extending radially from proximate the centre of the rotor 266 (or drive shaft 256/axis of rotation of the rotor) towards the perimeter of the rotor 266. Ridges 270 and 272 assist in directing food from atop the plate to the edges where it is comminuted. Ridge 272 further includes an upwardly directed protrusion 274 which further improves agitation and movement of organic waste to the periphery of the rotor 266.

Proximate the central aperture, the upper surface of the rotor 266 is also provided with a pre-processor coupling formation 276. In this case the coupling formation 276 includes a plurality of rectangular teeth 278 annularly spaced around the central aperture of the rotor and extending vertically from the upper surface of the rotor 266. Teeth 278 engage with complementary teeth of the pre-processing means 262.

Referring to FIGS. 3C and 3D, the pre-processing means 262 of the present embodiment is a shredder/agitation assembly 280 having a hollow spindle 282 from which a plurality of arms 284 radially extend. In this instance four equi-angularly spaced (with respect to the axis of rotation) arms are provided, though in alternative embodiments fewer arms (e.g. 1 arm, 2 arms, or 3 arms) or more arms could be provided. Arms 284 extend approximately normally/perpendicularly to the axis of rotation and in this embodiment form a cross shape (centred on the spindle 282) having a relatively longer axis (made up of relatively longer arms 284A) and a relatively shorter axis (made up of relatively shorter arms 284B). Extending from the upper surface of each arm 284 is a pair of upwardly protruding arcuate vanes 286, each vane 286 being convex towards the spindle 282 (or, alternatively, concave towards the wall of the funnel assembly 202). In some embodiments the vanes may have other shapes or configurations, for example the vanes may be straight instead of arcuate.

As depicted in FIG. 3D, which illustrates a top view of the shredder assembly 280, the vanes 286C and 286D on the short arms 284B are spaced at different radial displacements from the axis of rotation A to the vanes 286A and B on the long arms 284A such that their leading edges trace different paths to those of the vanes on the long arms 284A (and to one another) when the shredder 280 is rotated. This aids in agitating and shredding the organic waste. In this case the vanes 286 are positioned on the arms 284 such that corresponding opposite pairs of vanes 286A, 286B, 286C, and 286D trace four distinct circular paths on rotation: a first path traced by the innermost vanes 286A on each of the relatively longer arms 284A; a second path traced by the outermost vanes 286B on each of the relatively longer arms 284A; a third path traced by the innermost vanes 286C on each of the relatively shorter arms 284B; and a fourth path traced by the outermost vanes 286D on each of the relatively shorter arms 284B. Positioning/arranging the vanes to trace separate paths assists in agitation of the waste in the processing unit 200.

In alternative embodiments each different vane 286 may trace a different path, and/or the arms need not be equiangularly spaced about the axis of rotation, though in either of these cases care needs to be taken that the arms are evenly balanced. In addition, a strengthening rib 288 extends along the length of each of two opposite arms.

The base of the spindle 282 has a toothed profile, the teeth being complementarily shaped to teeth 278 of the rotor 266. When assembled, the teeth of the spindle 282 engage with the teeth 278 of the rotor 266 such that rotation of the rotor 266 also results in rotation of the spindle 282 (and shredder 280). The top of the drive shaft 256 is threaded to receive a lock-nut 290 (shown in FIG. 3C) which secures the waste processing (being, in this instance, the primary comminution means 260 and pre-processing means 262) in place. The length of the spindle 282 is such that the shredder 280 sits above the bowl assembly 220 and primary comminution means 260 (i.e. inside the funnel assembly 202). As will be appreciated, the length of the spindle 282 and separation distance between the shredder 280 and primary comminution means 260 will depend on the size and capacity of the comminution unit 202. In one embodiment the length of the spindle 282 is such that the shredder 280 (e.g. the under surface of the arms 284) sits at least 5 cm above the primary comminution means 260 (e.g. the upper surface of the rotor/grinding plate 262). The length of the spindle 282 may be such that the shredder 280 sits between 5 cm and 20 cm above the primary comminution means 260. Alternatively, the length of the spindle 282 may be such that the shredder 280 sits at least 10 cm above the primary comminution means. The length of the spindle 282 may be such that the shredder 280 sits between 10 cm and 15 cm above the primary comminution means 260. Further alternatively, the length of the spindle 282 may be such that the shredder 280 sits approximately 12 cm above the primary comminution means 260.

In addition, while the arms 284 of the pre-processing assembly 262 have been depicted as being approximately level with the region where the funnel assembly transitions from the angled lower segment 205 to the vertical middle segment 204, the comminution unit 202 may be configured such that the arms of the pre-processing assembly 262 rotate in a plane above the angled wall segment 212.

In use, the shredder 280 (or more generally the pre-processing means 262) is driven by motor 252 to rotate within the processing means about the axis of rotation. In this way the pre-processing means 262 rotates in the same plane as the primary comminution means 206. The arms 284 of the pre-processing means 262 act to downsize large pieces of organic waste, such as large pieces of fruit and vegetable. The pre-processing means 262 also agitates and downsizes green leaf matter (e.g. lettuce and other waste which is relatively light but relatively large) which could otherwise simply sit in the funnel assembly 202 and not feed naturally through the primary comminution means 266 under gravity (potentially creating a blockage preventing comminution of organic waste placed in the unit). The arcuate vanes 286 assist in this process by grabbing, agitating, and initially macerating the organic waste.

It will be appreciated that in some installations the pre-processor 262 component of the processing unit 200 may not be necessary. In this case, and as illustrated in FIG. 3E, the drive shall 256 is shorter in length such that the lock nut 290 secures against the top of the rotor 266.

Pump Assembly

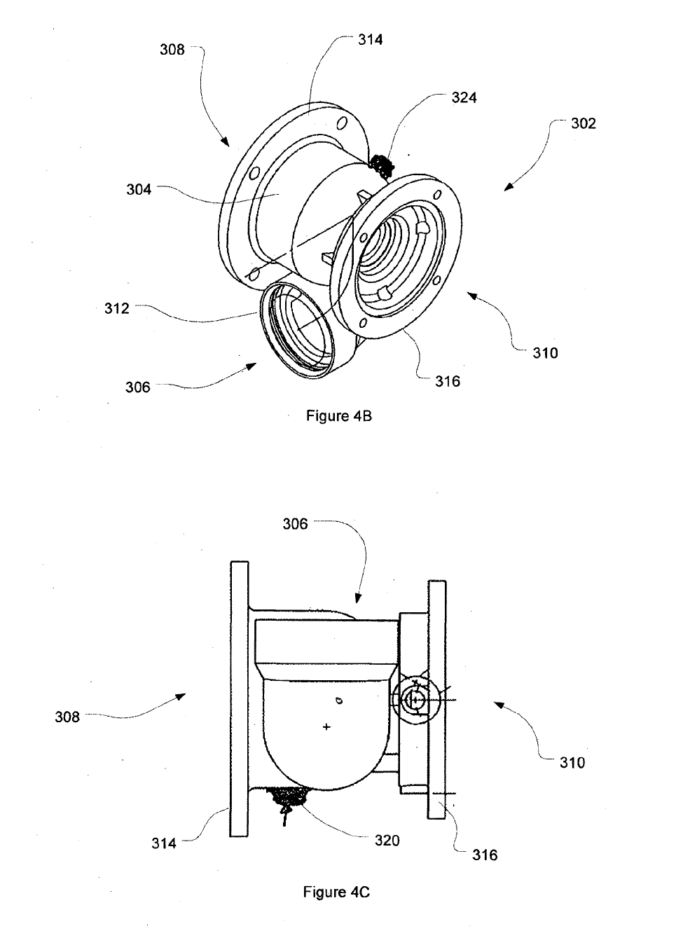

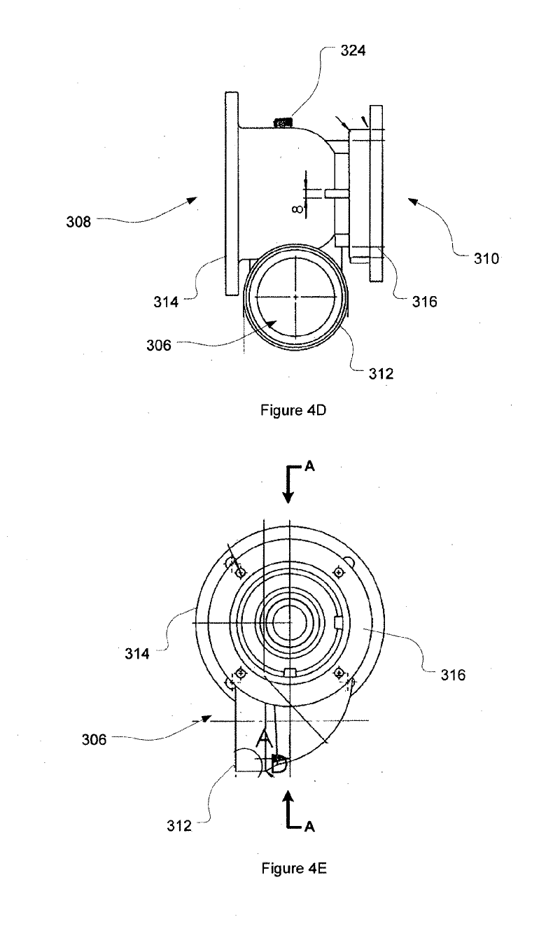

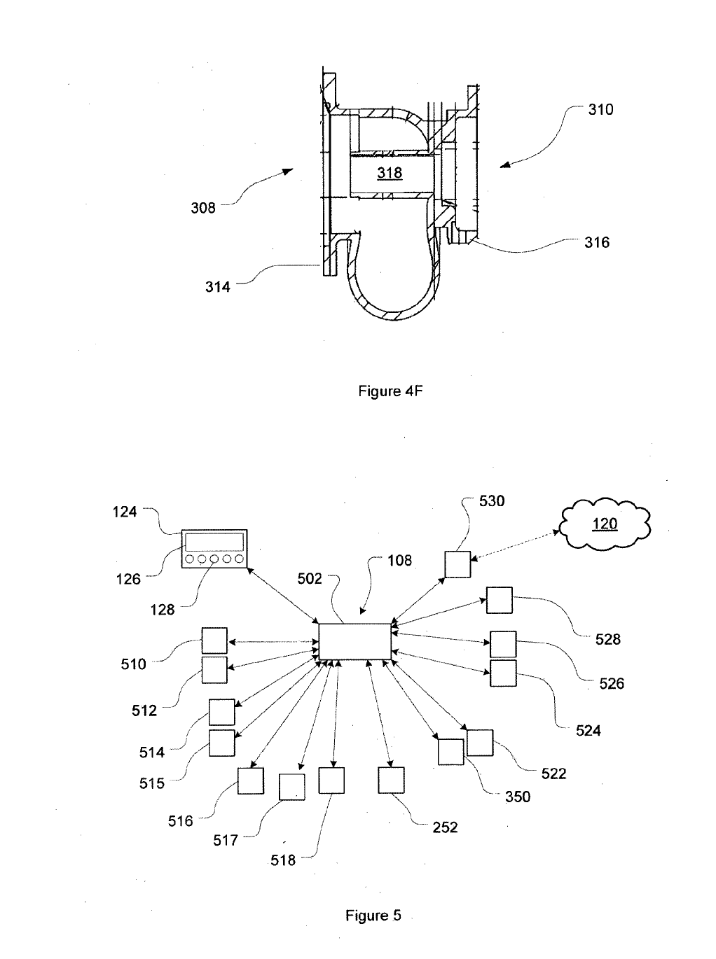

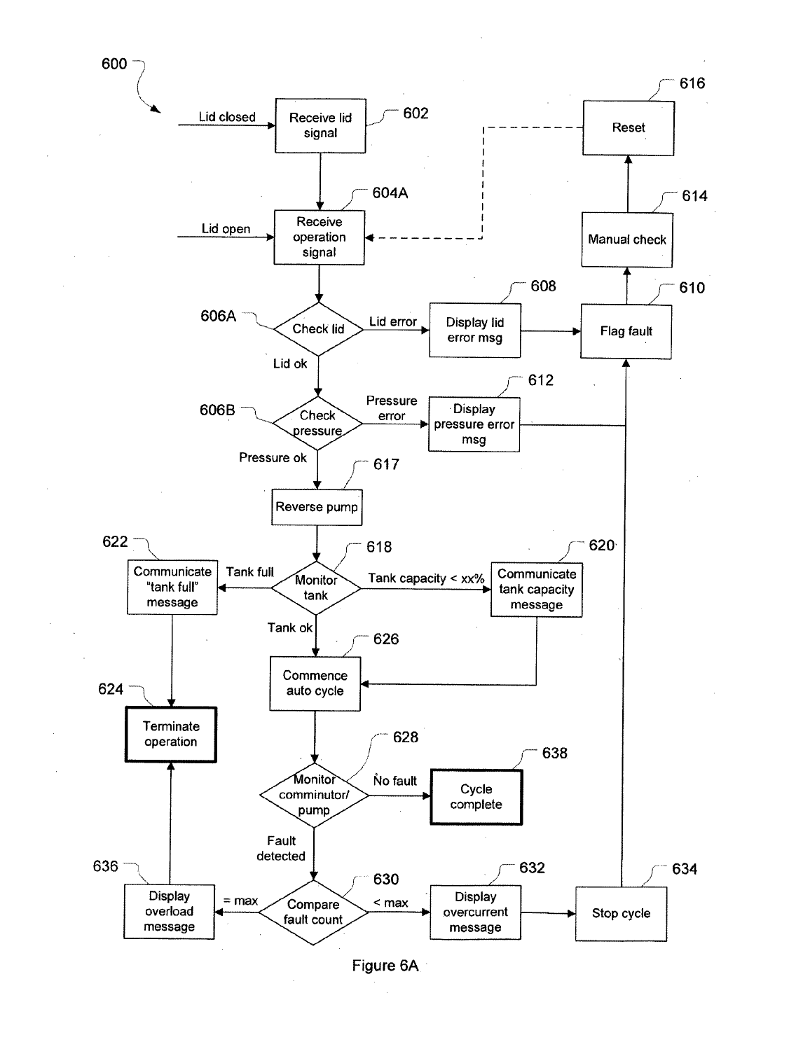

The pump assembly 104 will now be described in further detail with reference to FIGS. 4A to 4F. In this particular embodiment pump assembly 104 is conveniently housed inside the comminution unit 102, however the pump assembly 104 (or specific components there of, such as the pump mechanism) could be located outside the unit 102.

The pump assembly 104 of the present embodiment is similar to the 415 volt three phase MonoG60 pump manufactured by Monopumps, though improvements to the Mono G60 pump have been made as described herein to enhance its functionality for use with the organic waste treatment system.

FIG. 4A provides a schematic depiction of pump assembly 104. Pump assembly 104 generally includes a pump motor 350, a pump suction chamber 302, and a worm drive assembly 354. A pump drive shaft 356 extends from the pump motor 350 and through the suction chamber 302. The motor 350 (and pump drive shaft 356 extending therefrom) and worm drive assembly 354 form a pump mechanism. Pump drive shaft 356 engages with and drives a pump assembly macerator 358 and a worm drive rotor 360. The pump assembly macerator 358 macerates organic waste pumped through the pump assembly.

Worm drive rotor 360 extends through a complementally shaped worm drive stator 362, both of which are housed in a pump assembly end cap 364. To facilitate reverse operation of the pump assembly 104 (described further below), a fastener 366 is used to secure the worm drive rotor 360 to the pump drive shaft 356. In this instance the fastener 366 is a grub screw. Multiple fasteners 366 may, of course be used, as could alternative fastening means.

Various views of the pump suction chamber 302 are provided in FIGS. 4B to 4F—namely a perspective view in FIG. 4B, a front view in FIG. 4C, a top view in FIG. 4D, a left elevation view in FIG. 4E, and a sectional view in FIG. 4F (taken along section A-A of FIG. 4E). In these views “front”, “left”, and “bottom” are of course relative terms used for descriptive convenience.

The suction chamber 302 includes a body 304 defining a waste inlet 306, a suction chamber outlet 308, and a drive shaft opening 310. Waste inlet 306 includes a fitting 312 for engaging with fitting 248 (shown in FIG. 3B) of the bowl assembly 220 outlet 246. An apertured flange 314 is provided at the suction chamber outlet 308 for securing the suction chamber 302 to the pump assembly end cap 364. End cap 364 is provided with a waste outlet opening (not shown) which connects to waste transport line 110. An apertured flange 316 is also provided at the drive shaft opening 310 for securing the pump motor 350 to the suction chamber 302. Alternative fittings between the body 304 and connected components are, of course, possible.

Internally, and as can be seen in FIG. 4F, the drive shaft opening 310 steps down to an internal pipe section 318 which extends into the internal chamber of the body 304 and through which the pump drive shaft 356 extends.

Referring to FIG. 4C, at its base the suction chamber 302 is provided with a threaded bore for removably receiving a sump 320. Sump 320 is fitted with a rare earth magnet (or magnets) to form a secondary capture point or zone for attracting and capturing any magnetic material (such as cutlery fragments) that may have passed through the processing unit 200. This may occur where cutlery or other metallic objects are inadvertently placed in the processing unit 200 and are not captured by the magnetised funnel assembly 202 (or the processing unit is in accordance with an embodiment that omits the feature of a magnetised funnel assembly 202).

As can be seen in FIGS. 4B and 4D, the pump suction chamber 302 is provided with a second pump assembly inlet 324 (in this case a threaded water inlet bore) to which a second pump assembly water supply line is fitted (see connector 728 of the plumbing schematic shown in FIG. 7). In operation, water is supplied through the second pump assembly inlet 324 directly into the suction chamber 302. The volume of water suppled to the suction chamber 302 will depend on the size of the pump assembly. In some embodiments a volume of greater than 1 L per minute (for example between 1 L and 4 L per minute) is appropriate. In other embodiments a volume of approximately 2 L per minute will be appropriate. This assists in providing better suction, in particular where residual waste may be present which prevents or impedes water from the first pump assembly water supply line (at first pump assembly water inlet 250 via connector 724) from reaching the suction chamber 302, which can result in the suction chamber being empty and its operation being impeded.

Control Unit

Operation of the waste processing system 100 is effected by control unit 108. In this embodiment control unit 108 is illustrated as being housed in the comminution unit 102, and while this will generally be convenient the control unit 108 could be provided as part of the holding tank 106 or as an external component. Control unit 108 is, in this instance, a programmable logic controller (PLC) 502 as shown in FIG. 5.

In alternative embodiments, the control unit 108 may be a computer processing device having some or all of the components (or additional or alternative components) to those illustrated with respect to FIG. 9, and described below.

Referring to FIG. 5, which provides a logic block diagram of the waste processing system 100, the control unit 108 is connected to the various components of the waste processing system 100 to enable communication of data (including, as appropriate, control signals and feedback data) between the control unit 108 and the relevant component. As illustrated in FIG. 5, these connections include connections between the control unit 108 and:
The control panel 124, enabling the control unit 108 to control display 126 to display operational information and to receive user inputs from controls 128 (discussed in more detail below).
A lid actuator 510, enabling the control unit 108 to open and close the lid 122. Lid actuator 510 may, for example, be an electric lid actuator.
A lid position sensor 512, enabling the control unit 108 to receive lid position information (i.e. open or closed). The lid position sensor may 512 may, for example, be part of the electric lid actuator (e.g. a limit switch sensor).
A water inlet pressure switch 514.
A main water inlet valve 515, enabling the control unit 108 to control the supply of water during operation of the unit. The main water inlet valve 515 may be a solenoid valve.
An auto cycle valve 516, enabling the control unit 108 to control supply of water during an automatic operational cycle. The auto cycle valve may be a solenoid valve.
A wash cycle spray valve 517, enabling the control unit 108 to control supply of water during a wash cycle. The wash cycle valve may be a solenoid valve.
The comminution motor 252 of the processing unit 102, enabling the control unit 108 to activate/deactivate the comminution motor 252.
A comminution motor load sensor 518, enabling the control unit 108 to receive information regarding the load (e.g. current) on comminution motor 252. Motor load sensor 518 may, of course, be an integral part of the comminution motor 252.
The pump motor 350, enabling the control unit 108 to activate and deactivate the pump assembly 104.
A pump load sensor 522, enabling the control unit 108 to receive information on the load (e.g. current) of the pump motor 350. Pump load sensor 522 may, of course, be an integral part of the pump motor 350.
A holding tank capacity sensor assembly 524 for sensing the remaining capacity of waste in the holding tank and communicating this to the control unit 108, enabling the control unit 108 to receive holding tank capacity information. As discussed below, the holding tank capacity sensor assembly 524 may, for example, include a weight/load sensor arrangement and/or a level sensor arrangement.
A holding tank fail-safe sensor 526, enabling the control unit 108 to receive a signal that the holding tank is at capacity (or a signal from which this is determined) and all processing of waste should cease. The holding tank fail-safe sensor 526 may, for example, be a load cell assembly or a float switch.
An access panel sensor 528, enabling the control unit 108 to receive a signal that access panel 138 has been opened.
A communications interface 530, enabling the control unit 108 to receive control input from and send operational information to remote devices (e.g. server 116 or device 118) via a network (e.g. 120). The communications interface 530 may, for example, be a wired or wireless network interface controller, a telecommunications modem (such as a SAM modem manufactured by Intercel), or alternative wired or wireless communication means.

It will be appreciated that not all components described above are essential in all embodiments of the invention, and that even where all components are present they need not all be controlled by/communicate information to the control unit 108. By way of simple example, the lid actuator 510 may be omitted and the lid manually operated by a user.

Operational Logic

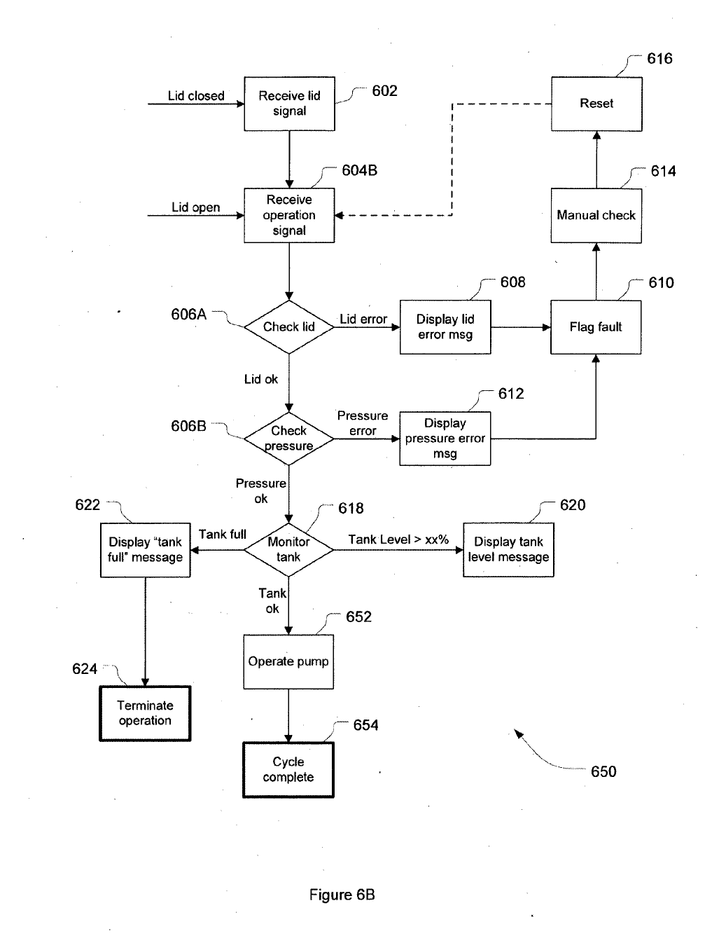

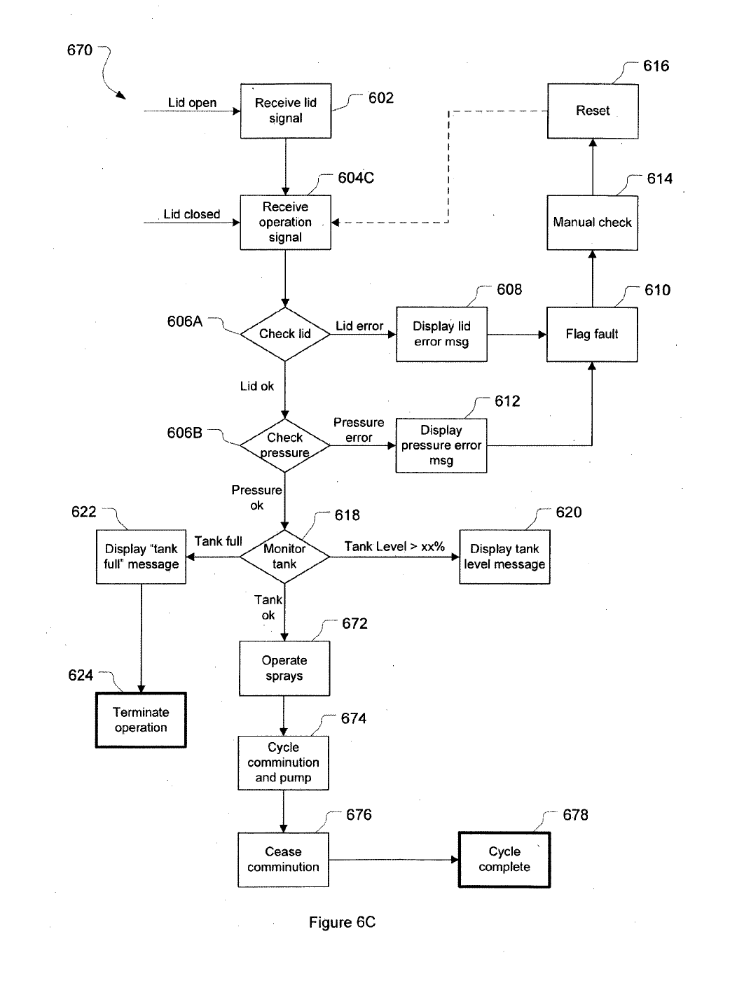

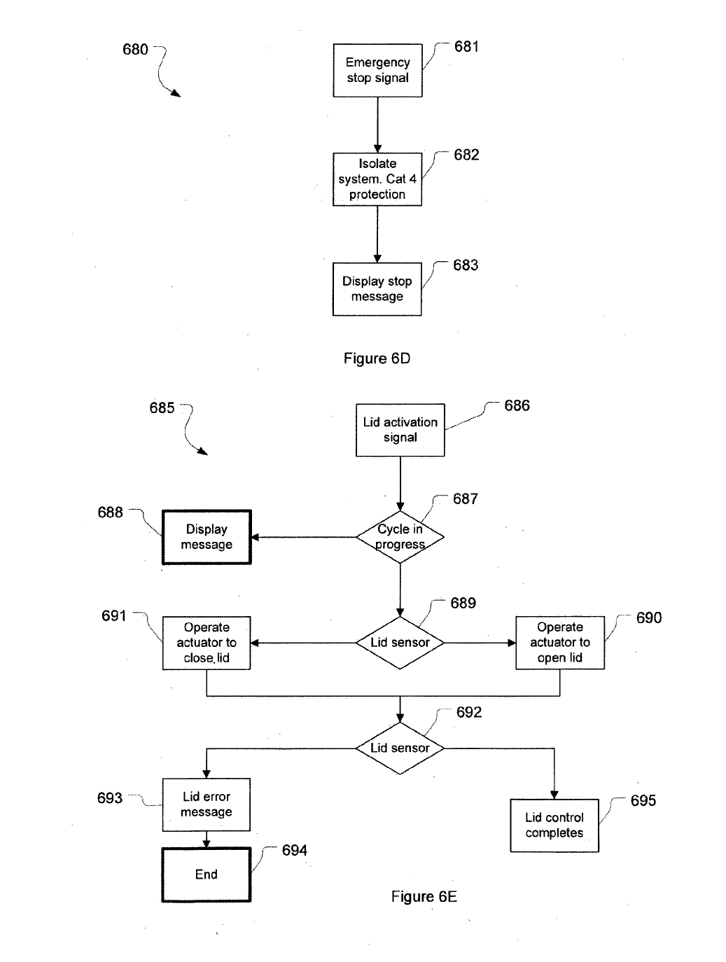

Referring to flowcharts of FIGS. 6A to 6E, various operations of the waste processing system 100 will be described. These operations are described in respect of the 5 specific control buttons discussed above (lid control 128A, automatic cycle control 128B, liquid cycle control 128C, wash cycle control 128D, and emergency stop button 128E), though additional or alternative operations and controls are of course possible. While the various steps of the flowcharts are depicted in a particular order, it will be appreciated that in many instances alternative orderings (or concurrent execution) of steps is possible, as is omission of some steps and/or inclusion of additional steps.

Automatic Cycle

FIG. 6A provides a flow chart 600 depicting the operation of the waste processing system 100 during an automatic processing cycle. This cycle is generally suitable for comminuting a normal load of solid organic waste matter, so that the “automatic cycle” can also be called a “comminuting cycle”.

If the lid 122 is in a closed position, at 602 the user activates the lid control 128A causing a lid signal to be sent, which is received by the control unit 108. In response the control unit 108 operates the lid actuator 510 to open the lid.

Once the lid is open, the user then fills (or partially fills) the funnel assembly 202 with organic waste, then at 604A activates the automatic cycle control 128B, sending an automatic cycle signal which is received by the control unit 108.

On activation of the automatic cycle control 128B, and unless the lid 122 is already closed (as sensed by the lid position sensor 512), the control unit 108 operates the lid actuator 510 to close the lid 122.

At 606 the control unit 108 performs a series of checks to ensure all is in order for the automatic cycle. In this particular embodiment, the status checks include: at 606A checking that the lid 122 is closed (reported by the lid position sensor 512); and at 606B checking that the water pressure is sufficient—i.e. that the water pressure in the water supply line 112 is at least at a predefined water pressure threshold (as reported by pressure switch 514). The predefined water pressure threshold may be 7 Bar.

At 608, if the lid check 606A fails (i.e. the lid sensor 512 reports the lid as being open), the control unit 108 displays a lid error message (e.g. “Lid error”) on display 126, and a system fault is flagged at 610. Similarly, if the water pressure check 606B fails (i.e. the pressure switch 514 reports that the water pressure is below the set threshold), the control unit 108 displays a water pressure error message (e.g. “Insufficient water pressure”) on display 126, and again flags a system fault.

If a system fault is flagged at 610, the user can undertake a manual system check at 614. If a lid error message is displayed (as a consequence of check 606A) this may involve checking for obstructions preventing the lid from closing. If a water pressure error is displayed (as a consequence of check 606B) the check will involve checking the water supply is connected and turned on. At 616, once the manual check is complete the user can switch the comminution unit 102 off and back on (via power switch 136) to reset the system, and attempt to recommence the operation by activation of the automatic cycle control 128B (or an alternative control).

If the manual check at 614 and reset at 616 does not fix the problem, servicing of the comminution unit 102 may be necessary.

At 617, if preliminary checks 606A and 606B are successful, the control unit 108 operates the pump motor 350 for a predetermined period of time (e.g. two seconds) in the reverse direction (though this may, of course, be included as part of the auto cycle commencement step 626). This serves to dislodge any organic waste that may have remained in the pump assembly from a previous operational cycle.

At 618 the control unit 108 checks (and monitors) the remaining capacity of the holding tank 106, as reported by the tank capacity sensor assembly 524 and/or the tank fail-safe sensor 526.

At 620, if the remaining capacity reported by the tank capacity sensor assembly 524 is less than a predefined threshold (for example, 20%), the control unit 108 communicates a tank capacity warning. In the present embodiment this communication includes displaying a message on the display 126 (for example a message “Tank xx% Full”) in addition to communicating a tank capacity message to the entity responsible for emptying the holding tank (e.g. a SMS message, email or similar identifying the particular tank or system and its current capacity).

Alternatively, at 622, if the control unit 108 receives a signal (from the capacity sensor 524 and/or tank fail-safe sensor 526) that the tank 106 is full, it communicates a “Tank Full” warning. As with the tank capacity message of 620, communication of the tank full warning in the present embodiment involves displaying message on the display 126 (e.g. “Tank 100% Full” or similar) and communicating a tank full message to the relevant entity (e.g. a SMS, email or similar identifying the tank and/or system and that the tank is full). In this case control unit 108 also locks down the processing unit at 624 and prevents further operation until the tank has been emptied.

The monitoring of the tank capacity at 618 continues throughout the operation cycle and if at any point during the cycle the capacity in the tank is reported as being full the cycle is interrupted.

If the tank 106 is not detected to be full the control unit 108 commences the processing cycle at 626. This involves the control unit 108 opening the main water inlet valve 515 and the auto cycle valve 516. As shown in the plumbing schematic (FIG. 7, discussed below) this supplies water to the sprays 214 and the pump assembly 104 (both into the pump inlet via first pump assembly water inlet 250, and directly into the pump suction chamber via second pump assembly inlet 324). In the automatic cycle the control unit 108 also commences a grinder run cycle (by activation of the comminution motor 252), and commences a pump run cycle (by activation of the pump motor 350).

At 628, and during the processing cycle, the control unit 108 monitors the load on the motor 252 (via the motor load sensor 518) and the load on the pump motor 350 (via the pump load sensor 522) to determine whether either are overloaded. A comminution motor overload is detected if the load on the comminution motor 252 is reported as exceeding a predefined comminution load threshold. Similarly, a pump overload fault is detected if the load on the pump motor 350 is reported as exceeding a predefined pump threshold.

In the present embodiment: a comminution motor overload is detected where the comminution motor operates 10% over the rated motor current for more than 2 seconds; a pump motor overload is detected where the pump motor the pump motor operates at the rated motor current for more than 2 seconds.

The relationship between the load on the comminution motor 252 and the volume of water added during the cycle can be varied according to the desired properties of the resulting slurry. For example, the relationship may be set so as to produce a slurry having (or approximately having) a defined pulp density or range of pulp densities, a defined moisture content or range of moisture contents, or a defined flow characteristic or range of flow characteristics. By way of example, the comminution unit may operate to produce slurry with a weight of about 1.1 tonne per cubic meter, and a moisture density of 75-85%.

The control unit 108 maintains a fault counter of the number of overload faults that have occurred in succession. On first operation of the unit 102 (or first operation of the unit 102 after a service reset) the fault counter is initialised at zero.

If the control unit 108 detects an overload in either the comminution motor 252 or pump motor 350, the control unit 108 increments the fault counter, and at 630 compares the value of the fault counter to a predetermined maximum fault number (for example, three faults).

If the value of the fault counter is less than the maximum fault number, the control unit 108 displays a fault error message on display 126 at 632. If the comminution motor fault threshold is exceeded the error message may be “Grinder overcurrent” or similar. If the pump mechanism fault threshold is exceeded the error message may be “Pump overcurrent”. The cycle is stopped at 634 (i.e. the control unit 108 terminates operation of the comminution motor 252 and pump motor 350), a fault is logged at 610, and the user may manually check and reset the system at 614 and 616 respectively before attempting to recommence the operation cycle. In addition, on detection of a comminution or pump overload event the control unit 108 may at 632 communicate the occurrence of the event to one or more entities as discussed below (e.g. by sending an SMS message to the entity responsible for maintenance of the unit).

If the value of the fault counter is equal to the maximum fault number, the control unit 108 displays an overload error message on display 126 at 636 and stops the cycle at 624. In this case further operation of the comminution unit 102 is prevented, and servicing of the unit 102 (either on-site or remotely) may be required before the unit 102 can be operated again.

If no faults are detected the operational cycle completes at 638. In one embodiment, completion of the operating cycle is detected where the control unit 108 detects that the load on the comminution motor 252 stays below a predefined minimum load threshold for a predetermined period of time, or if a cycle time out is reached. The cycle time out may be dependent on the capacity of the comminution unit, the type of material being processed, and the type of site. For example, the time out may be set to around 45 seconds for a 33 Litre unit and 90 seconds for an 80 Litre unit. The predefined minimum load threshold for the comminution motor 252 may be automatically adjusted according to the load sensed during a wash cycle (as described below), and the predetermined time period may be 5 seconds.

At completion of the operational cycle the control unit 108 deactivates the comminution motor 252 and pump motor 350, and resets the fault counter to zero. The control unit 108 also closes the main water inlet and automatic cycle water valves 515 and 516. In some embodiments the control unit 108 may also be configured to automatically open the lid 122 on completion of a cycle which both informs users of the cycle completion and allows further organic waste to be immediately added to the unit 102 for processing. The control unit 108 may also be configured to alert users to the completion of the cycle in additional or alternative ways, for example by displaying a message, flashing lights, playing an audible tone, sending an email/sms or similar.

If the comminution unit enters lock down mode as indicated by 624 (e.g. due to the tank being reported as full at 622, or the predefined number of overload faults being reached at 636), any operational cycle in progress is immediately interrupted/ceased, and further operation of the comminution unit 102 is prevented. At this point service of the unit 102 may be required.

Liquid Cycle

FIG. 6B provides a flow chart 650 depicting the operation of the waste processing system 100 during a liquid processing cycle. This cycle is suitable for processing a load of liquid organic waste matter.

In one embodiment the initial steps of the liquid cycle mirror steps 602 to 624 of the automatic operational cycle with the exception that at step 604B the user activates the liquid cycle control 128B, and the control unit 108 receives a liquid cycle signal. A further exception that the unit is filled or partially filled with liquid organic waste rather than solid organic waste. As such these steps will not be described again here.

In some embodiments the liquid cycle may be programmed to operate with the lid in the open position. In this case steps 606A and 608 (relating to checking the lid position) need not be performed.

Once the tank capacity has been checked at 618 (and not reported as being over the threshold capacity at 620 or full at 622), the control unit 108 commences the liquid processing cycle at 652. For the liquid cycle this involves the control unit 108 operating the pump motor 350 for a predetermined period of time (e.g. 10 seconds).

After operating the pump mechanism for the predetermined period of time, the liquid cycle completes at 654, and the control unit 108 deactivates the pump mechanism motor 350.

If the liquid cycle is configured to operate with the lid in a closed position, the control unit 108 may be configured to open the lid 122 at completion of the liquid cycle and/or signal completion of the cycle.

Wash Cycle

FIG. 6C provides a flow chart 670 depicting the operation of the waste processing system 100 during a wash cycle. This cycle is suitable for cleaning the comminution unit 102 when required (for example at the end of a day's processing).

The initial steps of the wash cycle also largely mirror steps 602 to 624 of the automatic operational cycle, with the exception that at step 604C the user activates the wash cycle control 128D, and the control unit 108 receives a wash cycle signal. A further exception is that with the wash cycle the user does not place any waste into the unit 102, and as such there is no need to open the lid if it is closed at the start of the process.

Once the tank capacity has been checked at 618 (and not reported as being over the threshold capacity at 620 or full at 622), the control unit 108 commences the wash cycle at 672. This involves, at 672, the control unit 108 operating the main water inlet valve 515 and the wash cycle valve 517, thereby supplying water to the sprays 214, for a set period of time. The time period can be set, for example, according to the length of the waste transportation line 110 connecting the comminution unit 102 to the holding tank 106.

On completion of the spray operation, the control unit 108 delays for a set period (e.g. 2 seconds), and then at 674 activates the comminution motor 252 and pump motor 350 for two 10 second cycles.

At 676 the control unit 108 terminates operation of the comminution motor 252, but continues to operate sprays (i.e. by leaving the main water inlet and wash cycle valves 515 and 517 open) and the pump motor 350.

At 678 the wash cycle terminates, and the control unit 108 closes the main water inlet and wash cycle valves 515 and 517 and terminates operation of the pump motor 350.

During the wash cycle the control unit 108 also monitors the load on the comminution motor 252 and pump motor 350. As there is no solid waste being processed during the wash cycle, the loads on the comminution and pump motors during the wash cycle can be used to calibrate the minimum load thresholds (or as reference levels from which these minimums can be derived) for these motors. As described above (e.g. in the automatic cycle), the minimum load thresholds are used to determine the completion of an operational cycle.

In one embodiment, the minimum load thresholds for the comminution and pump motors are taken as the average loads on the comminution/pump motors over multiple consecutive wash operations (e.g. 3 operations, 6 operations, 9 operations or an alternative number of operations). Typically this calibration will be performed on initial installation of a comminution unit 102. The minimum load thresholds may be recalibrated over the life of the unit 102, for example after relevant maintenance, after the completion of a certain number of processing cycles, and/or according to time the unit has been operating (e.g. every x months).

Emergency Stop

FIG. 6D provides a flow chart 680 depicting the operation of the waste processing system on activation of emergency stop control 128E.

At 681 the control unit 108 receives an emergency stop signal caused by a user activating the emergency stop control 128E.

At 682 the control unit 108 isolates the system and enables category 4 safety. Any open valves (e.g. the main water inlet, automatic cycle, and wash cycle valves 514, 515, and 516) are closed.

At 683 the control unit 108 displays an emergency stop message on the display 126 (e.g. “Emergency stop activated”.

Lid Control

FIG. 6E provides a flow chart 685 depicting the operation of the waste processing system 100 on activation of the lid control.

At 686 the control unit 108 receives a lid activation signal caused by a user activating the lid control 128A.

At 687 the control unit checks that an operational cycle is not currently in progress.

At 688, if an operational cycle is currently in progress no action is taken. In this instance the control unit 108 may, for example, display a message at on the display 126 indicating to the user that a cycle is in progress.

At 689, if an operational cycle is not currently in progress, the control unit 108 monitors the lid sensor 512. If the lid sensor 512 indicates the lid 122 is closed, the actuator 510 is operated to open the lid 122 at 690. If the lid sensor 512 indicates the lid 122 is open the actuator 510 is operated to close the lid 122 at 691.

At 692, the control unit again monitors the lid sensor 512. If the control unit 108 detects an error, a lid error message is displayed at 693 (e.g. “Lid Error”) and the system is shut down at 694. A fault is flagged and the user may check for obstructions and restart the system as described above at steps 610, 614, and 616 of the automatic operational cycle. An error will be detected where the expected state of the lid 122 is not reported by the lid sensor 512—e.g. where the lid 122 is initially open and after operation of the actuator 510 the lid 122 is still open, or where the lid 122 is initially closed and after operation of the actuator 510 the lid 122 is still closed.

Alternatively, if no error is detected at 692 the lid control process completes at 695, and the comminution unit 102 is ready for further use.

Plumbing

At a general level, the plumbing of the comminution unit 102 includes a water inlet path to a main water inlet valve 515 (shown schematically in FIG. 5). Downstream of the main water inlet valve 515 is an automatic cycle valve 516 (which, when open, supplies water to sprays 214 and the pump assembly 104), and a wash cycle valve 517 (which, when open, supplies water to the sprays 214). As such, and as described above, in order to supply water during an operational cycle the control unit 108 must open at least two valves: the main water inlet valve 515 and one of the automatic cycle or wash cycle valves 516 and 517.

With reference to FIG. 7 a specific example of plumbing suitable for the comminution unit 102 will be described by way of non-limiting example. It will be appreciated, however, that the plumbing of the comminution unit 102 may be achieved in a number of different ways, using additional and/or alternative fittings and components to those described below.

The mains water inlet, water supply line 112, passes through a tee fitting 702. One arm of the tee fitting 702 connects to a flexible hose with (for example) a trigger operated spray nozzle 704 to allow users to manually wash the comminution unit 102 (or use water from the water supply line 112 for other purposes). The other arm of tee fitting 702 leads to a pressure limit valve 706 which in this instance is a 500 kPa pressure limit valve.

Pressure limit valve 706 is, in turn, connected to another tee fitting 708, one arm of which is connected to pressure switch 514. Pressure switch 514 is connected to the control unit 108 to provide information on the water supply pressure.

The other arm of fitting 708 is connected to the main water inlet valve 515. The main water inlet valve includes a line strainer. Downstream of the main water inlet valve is a further tee fitting 710, one arm of which leads to an automatic cycle valve 516 and the other to the wash cycle valve 517.

The automatic cycle plumbing (i.e. the components downstream of the automatic cycle valve 516) include components to supply water to the water sprays 214 and the pump assembly 104. More specifically, the automatic cycle valve 516 connects to a needle valve 712, which in turn connects to a tee fitting 714. One arm of tee fitting 714 connects to sprays 214 (via a spray line including a 10 mm push fit hose connection 716 and 10 mm push fit tee connection 718). The other arm of tee fitting 714 connects to a further tee fitting 720. One arm of tee fitting 720 connects (via a 10 mm push fit hose connection 722) to a pump inlet hose 724. Pump inlet hose 724 is received by first pump assembly water inlet 250 and is for supplying water to the inlet of the pump assembly 104. The other arm of tee fitting 720 connects (via a 10 mm push fit hose connection 726) to pump suction chamber inlet hose 728. Suction chamber inlet hose 728 is received at the second pump assembly inlet 324 and is for supplying water directly to the pump suction chamber.

In one embodiment, the plumbing further includes a one way valve 740 positioned between the water sprays 736 and the second pump assembly water inlet 728 (more specifically between the tee fitting 714 and the connector 716). One way valve 740 is adapted to prevent the flow of water from the water sprays 736 towards the second pump assembly water inlet 728. This can be relevant where the suction generated by the pump assembly suction chamber generates suction through the upstream plumbing.

In addition, water reducers 742 and 744 may be provided upstream (respectively) of connectors 722 and 726. Water reducers 742 and 744 may be 2 L per minute water reducers. Alternatively, the water reducers may be 1 L-4 L.

The wash cycle plumbing (i.e. the components downstream of the wash cycle valve 517) include components for supplying water to the water sprays 214. This includes a 10 mm push fit hose connection 730 which in turn connects to a 10 mm push fit tee connection 732 via which water is suppled to the sprays 214.

Four sprays 214 are provided, each spray being a 10 mm push fit tee connecter connecting to spray line 734 and being fitted with a spray jet 736. As described above, the spray jets are positioned and have a spray angle to both supply liquid to the waste in the funnel assembly and to direct water onto the underside of the lid.

In the present embodiment, each of the main water inlet valve 515, automatic cycle valve 516, and wash cycle valve 517 is a solenoid valve in communication with and controlled by control unit 108. Suitably, the plumbing fittings (such as tee connectors 702, 708, 710, 718) may be brass.

Holding Tank

It will be appreciated that holding tank FIG. 106 may be any tank suitable for holding the organic slurry produced by the comminution unit 102.

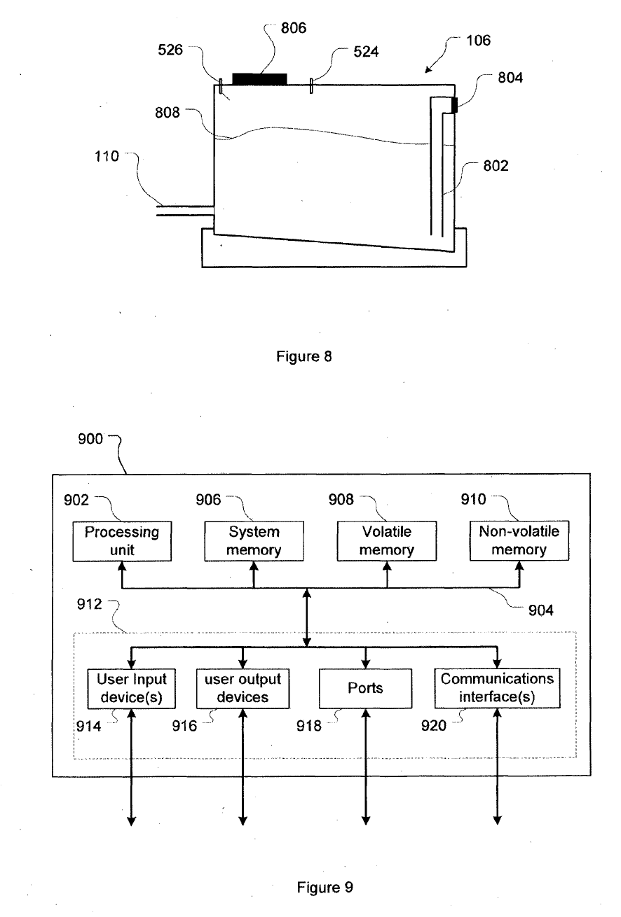

FIG. 8 provides, by way of non-limiting example, a depiction of a holding tank 106 suitable for this purpose. Tank 106 includes an internal pump out pipe 802, fitted with a valve and coupling 804 for connecting a pump out line of a tanker or similar (not shown) for pumping out the contents of the tank 106 in a pump out operation. Tank 106 also includes a hatch/lid 806 which can be opened for manual inspection and/or maintenance of the tank 106.

Tank 106 is also provided with a capacity sensor assembly 524 for sensing the current available capacity of the tank 106 (or sensing properties of the holding tank/waste therein that allow the available capacity to be calculated), and fail-safe sensor 526 which is tripped when the tank is full (or reaches a predetermined capacity). The remaining capacity of the tank 106 (and, accordingly, the volume/level/weight of waste currently in the tank 106) may for example be determined by a level sensor arrangement which senses the level 808 of waste in the tank 106, or a weight sensing arrangement which senses the weight of the tank (and waste held therein), thereby allowing the capacity occupied by the waste and the free capacity to be calculated. Suitable level sensors for sensing the level of slurry in the tank may include, for example, ultrasonic displacement sensors of the type manufactured by Omron (though alternative level sensors such as float switches, sonar level sensors, or laser level sensors are of course possible). A weight sensing arrangement may include one or more load cells suitably located to detect the weight of the tank. The fail-safe sensor 526 may be a float switch or similar. In the present embodiment signals from the capacity sensor 524 and fail-safe sensor 526 are transmitted by a cable to the control unit 106, though wireless transmission could be used. In addition, or by way of further alternative, holding tank 106 may communicate volume information directly to a server 116 or mobile device 118 via a network 120 (using a communication device such as a 3G/4G modem or similar).

System Monitoring, Data Logging/Reporting, Remote Control

In addition to controlling various operations of the waste processing system 100, the control unit 108 is configured to report on the various operational parameters and events monitored and logged. The reporting functionality is via communications interface 530, which allows the control unit to communicate data to local or remote devices (e.g. server 116 and remote device 118). Data may be communicated using any appropriate medium/protocol, and may ultimately be configured such that end users receive the communications by (for example) SMS, MMS, email, instant message etc.

The control unit 108 may be configured to communicate data or events to multiple user devices of various entities, e.g. (and depending on the particular event/data) to the operator of the system 100, the entity/individual(s) responsible for maintenance of the system 100, and/or the entity/individual(s) responsible for emptying the holding tank 106 (where these are different). For example, when the tank capacity sensor 524 reports the tank as being 80% full, the control unit 108 may send a message to both the entity operating the system 100 and the entity responsible for emptying the holding tank 106 (allowing them to plan a collection). By way of further and non-limiting example, the types of information and events that the control unit 108 may be configured to log and communicate may include:
A lid opening/closing error, and/or a predetermined number of successive lid opening/closing errors. This may, for example, indicate a faulty lid actuator 510, a faulty lid sensor 512, or a lid blockage.
A comminution unit reset (e.g. power off and power back on), and/or multiple successive comminution unit resets. This may indicate, for example, a general malfunction of the system 100.
The tank volume. This may provide, for example, advance warning as to when the tank is likely to need emptying. Where multiple systems are installed at multiple separate locations, knowledge of the current tank volume of each system (in some instances together with estimates as to when the tank of a system will be full or reach a certain percentage of capacity, as discussed below) allows the entity responsible for pumping out the holding tanks of the systems to plan an efficient pump-out schedule.
That the tank is full and needs to be emptied before further use of the comminution unit can occur.
That the reported tank volume (as sensed by the tank capacity sensor 524) has dropped despite not having been officially emptied (i.e. emptied by a pump-out operation carried out by the entity responsible for doing so). This may indicate, for example, a malfunctioning tank capacity sensor 524, tank leakage, or an unauthorised pump-out operation.
That the reported tank volume (as sensed by the tank capacity sensor 524) has remained the same despite one or more operational cycles of the comminution unit having occurred. This may indicate, for example, a malfunctioning tank capacity sensor 524 or leakage.
That the reported tank volume (by the tank capacity sensor 524) has not increased by a predetermined amount despite the occurrence of an operational cycle of the comminution unit. Where an operational cycle (e.g. automatic, liquid, wash as described above) is predicted to produce an associated minimum slurry volume, and the tank volume does not increase by this amount on performance of such a cycle, this may indicate a malfunctioning tank capacity sensor 524, a malfunctioning water valve (e.g. primary valve 514, pump valve 516, or spray valve 517), or leakage.
A comminution motor overcurrent event, and/or multiple successive comminution motor overcurrent events. This may indicate, for example, an obstruction in the comminution means or a malfunctioning load sensor 518.
A comminution motor overload event. This may indicate, for example, an obstruction in the comminution means or a malfunctioning load sensor 518.
A pump mechanism overcurrent event, and/or multiple successive pump mechanism overcurrent events. This may indicate, for example, an obstruction in the pump assembly 104 or a malfunctioning load sensor 522.
A pump mechanism overload event. This may indicate, for example, an obstruction in the pump assembly 104 or a malfunctioning load sensor 522.
Activation of the emergency stop control, and/or multiple successive emergency stop control activations.
A low/no water pressure message as reported by pressure switch 514.
An access panel warning indicating that the access panel 138 has been opened (as reported by sensor 528).

In addition, the control unit 108 is configured to log system usage data. Such data may be maintained on a local memory (and periodically uploaded to a remote server or device), or transmitted to a remote server or device (either in real time or batch mode). Operational data to be logged/reported may include, for example:
The number of operational cycles performed by the comminution unit 102. By timestamping each operational cycle and recording the type of operational cycle (e.g. automatic, liquid, wash) a user can view this data to determine the total number of cycles (or total number of a particular type of cycle) performed by the comminution unit, as well as usage trends of the system. For example, usage data may be processed to provide the average number of cycles (or number of particular types of cycles) per set time period (e.g. cycles per hour, cycles per day, cycles per week, cycles per month, cycles per year, or an alternative time period). The data may also be processed to display a usage graph showing the actual number of cycles (or specific types of cycles) on a y-axis against set time periods on the x-axis (e.g. hours, days, weeks, months, years etc).
The change in the volume of waste in the holding tank per operational cycle (or per particular type of operational cycle). Again, this data may be processed to provide information on the average volume produced by an operational cycle (or a particular type of operational cycle), or to chart the volume of the holding tank against time.
The average load on the comminution motor per normal (i.e. without an overcurrent/overload fault occurring) operation cycle (or per type of normal operational cycle).
The average load on the pump mechanism per normal (i.e. without an overcurrent/overload fault occurring) operation cycle (or per type of normal operational cycle).

Such operational information may be used in a variety of ways. For example, it may be used to view historical usage operation of a system 100. It may also be used to estimate normal and abnormal operation of the system 100—for example, if the comminution motor or pump mechanism loads of a system are unusually high compared to average loads this may indicate abnormal operation even if an overcurrent/overload event is not triggered. It may also be used to predict future usage of the system and plan system servicing and/or plan tank pump out operations.

For example, where multiple systems are installed at multiple locations, using data as to the current holding tank volumes of those systems, together with historical usage statistics for those systems, more efficient pump out schedules (involving a tanker visiting the various systems) can be planned. For example, tanks which are currently full need, of course, to be emptied. In addition, policy may dictate that where a tank is greater than a predetermined capacity (e.g. 90%) it also needs to be emptied. Usage trends/statistics may also be processed to indicate further tanks that may need to be emptied in the near future. For example, if the holding tank of a system 100 is reported as being at 70% capacity, and usage statistics for that system indicate that based on historical usage trends the volume of the tank will increase to 90% over the next three days, a pump out operation can be planned for in three days' time. Alternatively, a different system may also report its holding tank as being at 70% capacity, but historical usage statistics may predict that the next day of operation will produce more waste than will fit in the tank (i.e. more than 30% of the tanks capacity), in which case a pump out operation can be prioritised despite the fact that the tank has not reported as full or reached the predetermined threshold for a pump out operation. In this it is further recognised that in some instances system usage over a normal week will not be even (this would be shown by usage statistics for the tank). For example, a restaurant may experience a spike in usage over Thursdays to Saturdays when compared to Sunday to Monday. For such a restaurant, a tank volume of 70% on a Sunday may indicate that the tank can (based on historical usage) handle three more days of operation. The same message on a Wednesday, however, (i.e. 70% capacity) may indicate that the tank will handle only one more day of operation before a pump out is required.

In addition to providing usage information/statistics on a per-system basis, usage information of multiple processing systems 100 at different installations can be combined to provide even richer data and statistics. For example, data from all systems installed at fruit and vegetable vendors (or all vendors of a particular size) can be combined together to show average usage statistics/trends for fruit and vegetable vendors.

The control unit 108 may be configured to automatically communicate data either on occurrence of an event (e.g. if the system enters the lockdown mode the control unit 108 may immediately notify the relevant service entity), or at predefined time intervals (for example, the control unit 108 may be configured to send a weekly statistics message to the owner of the system 100 including usage information as described above). The control unit is also configured to receive and respond to remote requests for information. For example, the entity responsible for emptying the holding tank 106 may at any time send a request for the control unit 108 to communicate the volume of the holding tank 106, in response to which the control unit 108 communicates the relevant data.

In addition to reporting information via the communications interface 530, the control unit 108 is configured to receive operational commands and queries from authorised remote devices via the communications interface 530. These operational commands and queries may, for example, include:
A pump reversal command in response to which the control unit 108 operates the pump motor 350 in reverse (to assist in clearing potential blockages).
An overload reset command, in response to which the control unit 108 resets the overload counters thereby enabling operation of the system to continue.
A fault report query, in response to which the control unit 108 reports any detected faults.
Operational parameter queries in respect of various components (e.g. the capacity of the holding tank, the load on the comminution motor, the load on the pump motor 350, the water inlet pressure) in response to which the control unit 108 responds with the queried parameter data.

By controlling various components of the system 100 it may, in certain instances, be possible for troubleshooting and/or maintenance of the system 100 to be performed remotely by an authorised service entity. For example, and as described above, on occurrence of a terminating grinder overload (e.g. 636 in FIG. 6A) the control unit 108 may send a message to a computing device (e.g. a portable device such as a smart phone or a desktop computer or server) operated by the responsible servicing entity. On receipt of the message, the servicing entity may (again by way of example) send a command to the control unit 108 to operate the comminution motor 252 in a reverse direction for a predetermined period of time, operate the comminution motor 252 in the normal direction for a predetermined period of time, and provide to the service entity information on the load on the comminution motor 252 (sensed by sensor 518) during the operation. If the load on the motor during operation in the normal direction is acceptable, the service entity may then send a reset signal to the comminution unit allowing its further operation by the user.

User Device

As discussed above, control unit 108 may be configured to transmit various operational data to one or more user devices and, in certain instances, receive commands requests from user devices. Generally speaking, any computer processing device capable of receiving information from the control unit 108 (either directly or via a server/other device), displaying or otherwise communicating the data from the control unit 108 to the user, receiving user input, and transmitting data back to the control unit 108 (either directly or via a server/other device) will be suitable. Such devices include, for example, servers, desktops, laptops, notebooks, netbooks, tablets, mobile phones, smart phones, and personal digital assistants.

FIG. 9 provides a functional block diagram of the various components of a computer processing device 900 suitable for use with the invention as a user device. In some embodiments of the invention the control unit 108 itself may also be a computing device such as device 900.

Computer processing device 900 includes a processing unit 902. The processing unit 902 may include a single processing device (e.g. a microprocessor or other computational device), or may include a plurality of processing devices.

Through a communications bus 904 the processing unit 902 is in data communication with a system memory 906 (e.g. a BIOS), volatile memory 908 (e.g. random access memory including one or more DRAM modules), and non-volatile memory 910 (e.g. one or more hard disk drives, solid state drives). Instructions and data to control operation of the processing unit 902 are stored on the system, volatile, and/or non-volatile memory 906, 908, and 910.

The computer processing device 900 also includes one or more input/output interfaces (indicated generally by 912) which interface with a plurality of input/output devices. As will be appreciated, a wide variety of input/output devices may be used, including intelligent input/output devices having their own memory and/or processing units. By way of non-limiting example, the device 900 may include: one or more user input devices 914 (e.g. keyboard, mouse, a touch-screen, trackpad, microphone, etc); one or more user output devices 916 (e.g. CRT display, LCD display, LED display, plasma display, touch screen, speaker, etc); one or more ports 918 for interfacing with external devices such as drives and memory (e.g. USB ports, Firewire ports, eSata ports, serial ports, parallel ports, SD card port, Compact Flash port, etc); and one or more communications interfaces 920 allowing for wired or wireless connection to a communications network 120 (e.g. a Network Interface Card etc).

Communication with the communications network 120 (and other devices connected thereto) will typically be by the protocols set out in the layers of the OSI model of computer networking. For example, applications/software programs being executed by the processing unit 902 may communicate using one or more transport protocols, e.g. the Transmission Control Protocol (TCP, defined in RFC 793) or the User Datagram Protocol (UDP, defined in RFC 768).

The computer processing device 900 runs one or more applications to allow a user to operate the device 900. Such applications will typically include at least an operating system (such as Microsoft Windows®, Apple OSX, Apple iOS, Unix, Linux, Android).

Where the computer processing device 900 is a user device, it will also be provided with application software allowing the device to receive information from the control unit 108 of the processing system 100 and to communicate that information to a user of the device (e.g. by displaying the information on a display or via audio signals from a speaker/headphone jack). The information communicated to the user may include an identifier of the system 100 which the data relates to (e.g. a serial number, the address at which the system is installed, and/or a unique system name), and the application may provide various controls allowing the user to view different information concerning the system.

For example, the application may provide a “tank volume” control which displays the tank volume reported by the system in question, together with the date/time the data was current at. A refresh/update button may also be provided which, when activated, results in the device sending a request (via communication interface 920) to the system and receiving the current tank volume in response.

The application may also provide system operation controls which, when activated, result in the device transmitting operational commands to a system control unit. For example, the application may provide a “system shut down” control which, when activated by a user of the device, sends a shut down message to the control unit 108 of a system 100 which, in turn, shuts the system down.

The application may also be configured to automatically communicate (visually and/or audibly) the occurrence of certain events to the user. For example, the application may automatically alert the user of the device when a tank of a system is reported as full (or at a predetermined capacity) or when a grinder/pump overload occurs.

In some embodiments, information may be transmitted to and from the user device by way of SMS. In this case, for example, operational information regarding a particular system is received at the user device as a SMS message, and the system 100 may be controlled (or information requested) by sending SMS messages with pre-defined commands back to the system 100.

It will be understood that the invention disclosed and defined herein extends to all alternative combinations of two or more of the individual features mentioned or evidence from the text or drawings. All of these different combinations constitute various alternative aspects of the invention.

The foregoing describes embodiments of the present invention and modifications obvious to those skilled in the art can be made thereto without departing from the scope of the present invention.

1. A comminution unit for an organic waste treatment system, the comminution unit including:
a comminution means for comminuting organic waste;
a funnel assembly for receiving the organic waste, the funnel assembly being positioned above the comminution means and including at least one inwardly angled section for directing organic waste to the comminution means;
a pre-processing assembly being positioned in the funnel assembly and above the primary comminution means, the pre-processing assembly adapted to agitate and shred the organic waste;
a motor for driving the primary comminution means and the pre-processing assembly about an axis of rotation; and
a waste outlet positioned below the comminution means and via which comminuted organic waste is transported away from the comminution unit, wherein the pre-processing assembly includes one or more arms extending radially from the axis of rotation.

2. A comminution unit according to claim 1, wherein the pre-processing assembly includes a spindle from which the one or more arms extend, the spindle having a length selected to position the pre-processing assembly above the comminution means.

3. A comminution unit according to claim 2, wherein the length of the spindle positions the pre-processing assembly at least 5 cm above the comminution means.

4. A comminution unit according to claim 2, wherein the length of the spindle positions the pre-processing assembly at least 10 cm above the comminution means.

5. A comminution unit according to claim 2, wherein the motor drives the comminution means and the pre-processing assembly via a drive shaft, and wherein the drive shaft is received in the spindle.

6. A comminution unit according to claim 2, wherein the comminution means includes a rotor and wherein the pre-processing assembly is coupled to the rotor via a coupling formation.

7. A comminution unit according to claim 6, wherein the coupling formation includes a plurality of teeth provided on an upper surface of the rotor, and a plurality of complementarily shaped teeth provided on a base of the spindle.

8. A comminution unit according to claim 1, wherein at least one of the one or more arms of the pre-processing assembly includes one or more vanes extending from the one or more arms.

9. A comminution unit according to claim 8, wherein the one or more vanes have a concave profile.

10. A comminution unit according to claim 8, wherein the pre-processing comminution means includes at least two vanes, each vane positioned at a different radial distance from the axis of rotation so that each vane traces a distinct circular path on rotation of the pre-processing means by the motor.

11. The comminution unit of claim 1, wherein the pre-processing comminution means includes:
a first pair of arms, each arm including an inner and an outer concave vane positioned at different radial distances from the axis of rotation so that each vane traces a distinct circular path on rotation of the pre-processing means by the motor; and
a second pair of arms, each arm including an inner and an outer concave vane positioned at different radial distances from the axis of rotation so that each vane traces a distinct circular path on rotation of the pre-processing means by the motor.

12. The comminution unit of claim 11 wherein:
the inner concave vanes of the first pair of arms trace a same, first circular path;
the outer concave vanes of the first pair of arms trace a same, second circular path;
the inner concave vanes of the second pair of arms trace a same, third circular path; and
the outer concave vanes of the second pair of arms trace a same, fourth circular path, and wherein the first, second, third, and fourth circular paths are different circular paths.

13. A pump assembly for an organic waste treatment system, the pump assembly including:
a pump motor for driving the pump assembly;
an inlet for receiving water and comminuted organic waste;
an outlet through which the comminuted organic waste is pumped by a pump mechanism;
a suction chamber between the pump assembly inlet and the pump assembly outlet; and
a pump assembly water inlet for admitting water directly into the suction chamber.

14. An organic waste treatment system including:
a funnel assembly for receiving organic waste;
a comminution means for comminuting the organic waste, the comminution means being located downstream of the funnel assembly;
a motor for driving the comminution means;
a pump assembly for pumping comminuted organic waste away from the comminution means, the pump assembly including:
a pump assembly inlet for receiving the comminuted organic waste;
a pump assembly outlet through which the comminuted organic waste is pumped by a pump mechanism; and
a suction chamber located between the pump assembly inlet and the pump assembly outlet, wherein the organic waste treatment system further includes a main water inlet connected by plumbing to:
one or more water sprays located in the funnel assembly;
a first pump assembly water inlet for admitting water at a location between the comminution means and the pump assembly inlet; and
a second pump assembly water inlet for inletting water directly into the suction chamber.

15. The organic waste treatment system of claim 14, wherein the plumbing includes a one way valve located positioned between the one or more water sprays and the second pump assembly water inlet, the one way valve preventing the flow of water from the one or more water sprays towards the second pump assembly water inlet.

16. The organic waste treatment system of claim 14 or claim 15, wherein the pump assembly further includes a macerator for macerating organic waste pumped through the pump assembly.

17. The organic waste treatment system of claim 14, further including a pre-processing assembly adapted to agitate and shred the organic waste, the pre-processing assembly being located upstream of the comminution means.

18. The organic waste treatment system of claim 14, wherein the pump mechanism includes a pump motor having a pump assembly drive shaft, and a pump rotor attached to the pump assembly drive shaft using at least one fastener permitting the pump mechanism to be operated in both forward and reverse directions without decoupling of the pump rotor from the pump assembly drive shaft.
